(19) United States
(12) Patent Application Publication
(10) Pub. No.: US 2013/0293581 A1
(43) Pub. Date: Nov. 7, 2013

(54) Back-to-Back Video Displays

(71) Applicants: Alexander David Wissner-Gross, Combridge, MA (US); Timothy Michael Sullivan, Cambridge, MA (US); Robert Joseph Wolf, Sandy, UT (US); Robert Vern Brazell, Salt Lake City, UT (US)

(72) Inventors: Alexander David Wissner-Gross, Combridge, MA (US); Timothy Michael Sullivan, Cambridge, MA (US); Robert Joseph Wolf, Sandy, UT (US); Robert Vern Brazell, Salt Lake City, UT (US)

(21) Appl. No.: 13/875,890

(22) Filed: May 2, 2013

Related U.S. Application Data
(60) Provisional application No. 61/641,787, filed on May 2, 2012.

(51) Int. Cl. G06T 19/00; H04N 7/18

(52) U.S. Cl. CPC G06T 19/006; H04N 7/18
USPC 345/633; 348/150

(57) ABSTRACT

The present invention extends to methods, systems, and computer program products for displaying advertisements to customers using multiple display devices that are positioned in a back-to-back orientation. Visual content captured by one display device can be transmitted to the other display device for display such that the display devices appear to be transparent. In this way, items positioned in front of one display device can be captured by the display device and augmented prior to being displayed on the other display device. These augmentations can provide dynamic and customized advertisements of items as they appear on a shelf or other location within a retail environment to thereby increase a customer's interest in the product while the customer is near the product.

### CROSS-REFERENCE TO RELATED APPLICATIONS

This application claim priority to U.S. Provisional Patent Application No. 61/641,787, filed May 2, 2012.

### BACKGROUND

Advertising is the process through which companies attempt to convince customers to purchase their products. Advertising takes many forms including radio advertisements, in-store audio advertisements, television advertisements, billboards, etc.

One of the major challenges in creating effective advertising is predicting how a customer will respond to a particular advertisement. Traditionally, companies have used focus groups and surveys in order to obtain customer response information about their products and advertisements. Customer response information can help improve advertisements. Unfortunately, customer response information is occasionally inadequate or inaccurate. Additionally, the significant time delay between obtaining the customer response data and broadcasting the developed advertisement can be too long and consumer preferences may change.

In retail environments, point-of-purchase advertising is commonly used to attract and entice customers to purchase items that are stored and displayed on shelves. Point-of-purchase advertising includes various advertisements displayed within the store. The effectiveness of point-of-purchase advertisements often depends on the ability of the display to catch the customer's attention. Currently, there are several ways in which manufactures and merchants try to catch a customer's attention at the point of purchase. For example, some manufactures and merchants have placed static advertisements in close proximity to a target product. These static advertisements often rely on artistry, color, advertised price, or shelf location to attract customers. These static displays have significant weaknesses, including blocking store traffic, being knocked over, and occasionally being unable to draw customer attention.

Thus, while current advertising systems and methods provide some advantages, it would be desirable to develop improved advertising systems and methods that can use timely and reliable information and can effectively entice store customers to purchase certain product.

### BRIEF SUMMARY

The present invention extends to methods, systems, and computer program products for displaying advertisements to customers using multiple display devices that are positioned in a back-to-back orientation. Visual content captured by one display device can be transmitted to the other display device for display such that the display devices appear to be transparent. In this way, items positioned in front of one display device can be captured by the display device and augmented prior to being displayed on the other display device. These augmentations can provide dynamic and customized advertisements of items as they appear on a shelf or other location within a retail environment to thereby increase a customer's interest in the product while the customer is near the product.

In some embodiments, the present invention is implemented as a method for capturing content with one display device and displaying the captured content on the other display device. Visual content is captured using a camera of a first display device. The visual content captures one or more items positioned in front of the first display device. The first display device is positioned in a back-to-back orientation with a second display device. The visual content is transmitted to the second display device where it is displayed thereby giving the appearance that the first and second display devices are transparent.

In other embodiments, the present invention is implemented as a system for displaying augmented advertisements using multiple display devices positioned in a back-to-back orientation. The system includes a first display device having a front facing camera for capturing visual content of items positioned in front of the first display device, and a second display device having a front facing camera for capturing visual content of items positioned in front of the second display device. The first and second display devices are mounted in a back-to-back orientation such that the front facing cameras of each display device face in operate directions. Each display device is configured to capture visual content of items positioned in front of the display device and transmit the captured visual content to the other display device for display on the other display device.

In other embodiments, the present invention is implemented as a method for displaying a customized advertisement on a first display device by augmenting visual content captured by a second display device that is positioned in a back-to-back orientation with the first display device. Visual content is captured using a camera of the second display device. The visual content captures one or more items that are positioned in front of the second display device. The presence of a customer in front of the first display device is detected. An augmentation to apply to the captured visual content based on the identity of the detected customer is determined. The augmentation is applied to the captured visual content to emphasize at least one of the items in the captured visual content. The captured visual content with the augmentation is then displayed on the first display device while the customer is positioned in front of the first display device.

This summary is provided to introduce a selection of concepts in a simplified form that are further described below in the Detailed Description. This Summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computing environment in which the present invention can be implemented;

FIGS. 2A and 2B illustrate a side and front perspective view respectively of a display set comprising two display device positioned in a back-to-back orientation;

FIG. 3 illustrates a display set mounted to a shelf in a retail environment;

FIG. 4 illustrates the display set of FIG. 3 while an item captured by one display device is being displayed on the other display device;

FIG. 5 illustrates how the display set can adapt what visual content is displayed based on the eye level of a customer detected in front of one of the display devices;

FIG. 6 illustrates how the display of an item captured by one display device can be augmented when displayed on the other display device;

FIG. 7 illustrates how a display set can identify the presence of a customer in proximity of the display set;

FIG. 8 illustrates a flowchart of a method for capturing content with one display device and displaying the captured content on the other display device; and

FIG. 9 illustrates a flowchart of a method for displaying a customized advertisement on a first display device by augmenting visual content captured by a second display device that is positioned in a back-to-back orientation with the first display device.

### DETAILED DESCRIPTION

The present invention extends to methods, systems, and computer program products for displaying advertisements to customers using multiple display devices that are positioned in a back-to-back orientation. Visual content captured by one display device can be transmitted to the other display device for display such that the display devices appear to be transparent. In this way, items positioned in front of one display device can be captured by the display device and augmented prior to being displayed on the other display device. These augmentations can provide dynamic and customized advertisements of items as they appear on a shelf or other location within a retail environment to thereby increase a customer's interest in the product while the customer is near the product.

In some embodiments, the present invention is implemented as a method for capturing content with one display device and displaying the captured content on the other display device. Visual content is captured using a camera of a first display device. The visual content captures one or more items positioned in front of the first display device. The first display device is positioned in a back-to-back orientation with a second display device. The visual content is transmitted to the second display device where it is displayed thereby giving the appearance that the first and second display devices are transparent.

In other embodiments, the present invention is implemented as a system for displaying augmented advertisements using multiple display devices positioned in a back-to-back orientation. The system includes a first display device having a front facing camera for capturing visual content of items positioned in front of the first display device, and a second display device having a front facing camera for capturing visual content of items positioned in front of the second display device. The first and second display devices are mounted in a back-to-back orientation such that the front facing cameras of each display device face in operate directions. Each display device is configured to capture visual content of items positioned in front of the display device and transmit the captured visual content to the other display device for display on the other display device.

In other embodiments, the present invention is implemented as a method for displaying a customized advertisement on a first display device by augmenting visual content captured by a second display device that is positioned in a back-to-back orientation with the first display device. Visual content is captured using a camera of the second display device. The visual content captures one or more items that are positioned in front of the second display device. The presence of a customer in front of the first display device is detected. An augmentation to apply to the captured visual content based on the identity of the detected customer is determined. The augmentation is applied to the captured visual content to emphasize at least one of the items in the captured visual content. The captured visual content with the augmentation is then displayed on the first display device while the customer is positioned in front of the first display device.

Exemplary Operating Environment

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

Overview of Display Devices

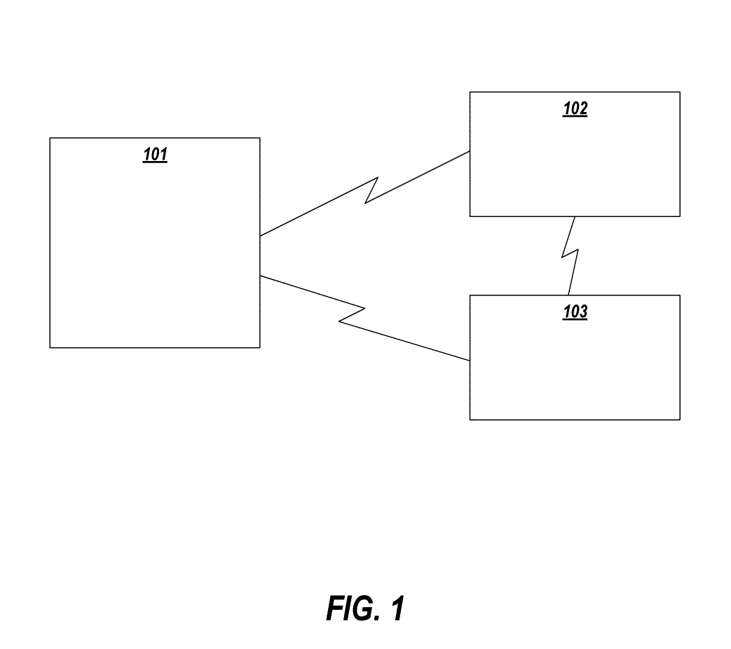

FIG. 1 illustrates an exemplary computer environment 100 in which the present invention can be implemented. Computer environment 100 includes a server 101, a first display device 102, and a second display device 103. In some embodiments, display devices 102 and 103 can be tablet computing devices or another display device (e.g. a television) having sufficient computing resources for implementing the functionality described below.

Display devices 102 and 103 can intercommunicate as well as communicate with server 101. For example, display devices 102 and 103 can be configured to communicate via a wired or wireless connection. Display devices 102 and 103 can intercommunicate or communicate with server 101 to convey information relevant for displaying content on either of display devices 102 and 103 as will be further described below. Accordingly, a system for providing customized advertisements may or may not employ a server.

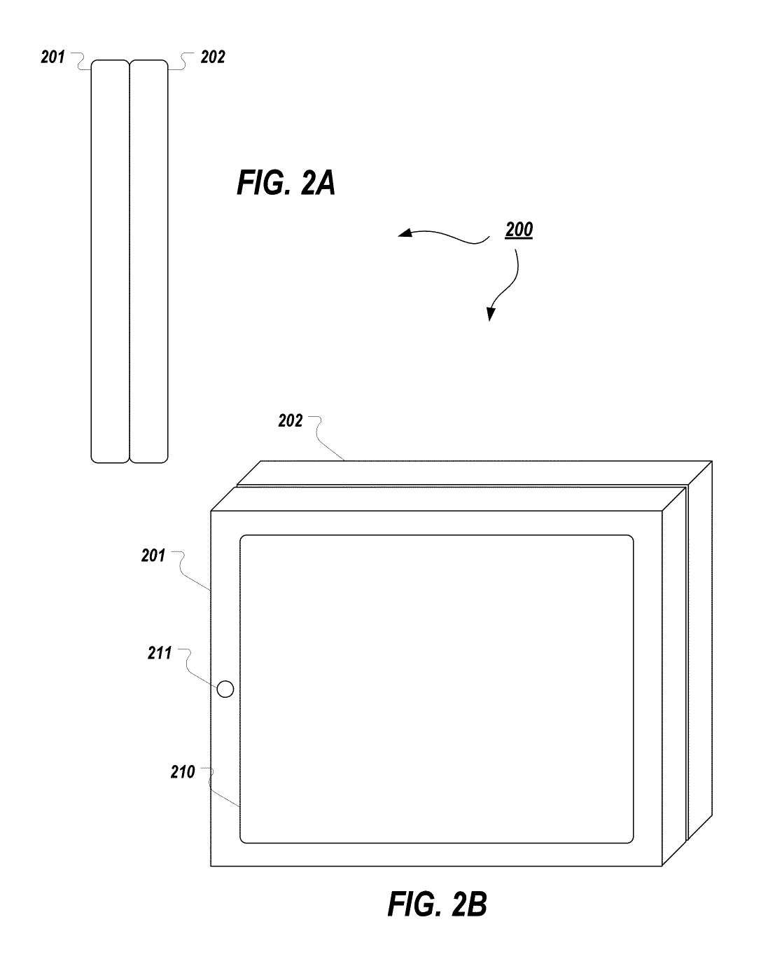

FIGS. 2A and 2B illustrate a side and front perspective view respectively of a display set 200 comprised of two display devices 201 and 202 that are connected in a back-to-back manner. Display devices 201 and 202 can be used for advertising, information, or amusement in retail environments. When placed back to back, advertisements can be displayed to customers on both sides of display set 200. The front side of each display device (visible on display device 201 in FIG. 2B) can include a display 210 and a camera 211. Each display device 201, 202 can optionally include a microphone or other input device. In some configurations, display set 200 can be secured to a shelf or other items within a store using a variety of mounts, brackets, covers, or other suitable structures (not shown).

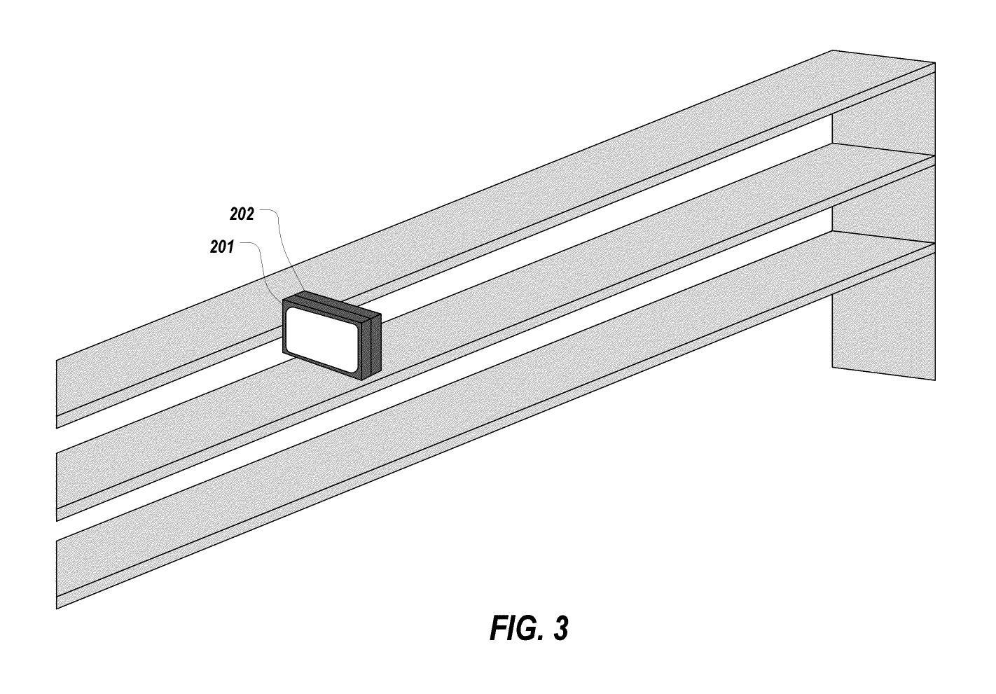

FIG. 3 illustrates an example of how display set 200 can be attached to a shelf in a retail environment. As shown, display devices 201 and 202 can be mounted in some manner to a shelf so that the displays 210 of each display device are visible from opposite ends of the aisle.

In some embodiments, display devices 201 and 202 can be paired forming a digital bond between the two display devices that allows them to establish a communication link. This pairing allows the display devices to coordinate the display of content on one or both displays 210 as will be further described below.

In some embodiments, during the pairing process, the display devices may create a link key stored on one or both display devices. When one display device initiates communication with the other bonded display device, the link key can be identified and authenticated and the communication can be permitted. Two display devices can be paired using various techniques, including synchronized touching of their displays 210, acoustic handshaking, low-frequency vibration handshaking, and communication over a wireless link (e.g., Bluetooth, Wi-Fi, Wi-Max, or other suitable wireless communication link). For instance, display set 200 can be paired when one or both of display devices 201, 202 detects a wireless signal having at least a threshold signal strength coming from the other display device.

As mentioned, some pairing can be accomplished using acoustic handshaking or low-frequency vibration handshaking. Acoustic handshaking involves the transmission of an acoustic ID from one display device to another. A unique acoustic ID can be assigned to each display device and can be transmitted using a speaker of one display device and received using a microphone of another display device. The receiving display device can permit future authentication and communication from the transmitting display device. In a similar manner, low-frequency vibrations can communicate a unique identification from one display device to another during a pairing process.

Once paired, each display device can communicate data to the other bonded display device. Various types of data can be exchanged and used in displaying advertisements, providing amusement, or communicating information. For example, the video captured from a camera 211 on one display device can be transmitted to and displayed on the opposite display device.

Display set 200 can display synchronized or unsynchronized video feeds on the displays 210 of the two display devices 201, 202. Synchronized video feeds may be provided when a single customer is identified near display set 200. In these instances, the same video can be displayed synchronously on both display devices since the customer may easily move from one side of the display set to the other. In some circumstances, synchronized display devices can omit or redact selected content from one of the display devices, such as, private or personal information, a customer's a name, phone number, password, product query, or other information that may be displayed or input on a first display device.

Alternatively, display set 200 may provide unsynchronized video feeds, in which separate images are displayed on each of display devices 201, 202. This setting can be particularly useful when customers are located on both sides of display set 200. For example, when the display set recognizes that customers are approaching the display set from different sides, separate images or video feeds can be displayed on the separate display devices. Moreover, when customers are only identified on one side of the display set, one display device can be placed in a sleep mode. The sleeping display device can be awakened when a customer is identified on the other side of the display set.

Displaying Content on One Display that was Captured by Another Display

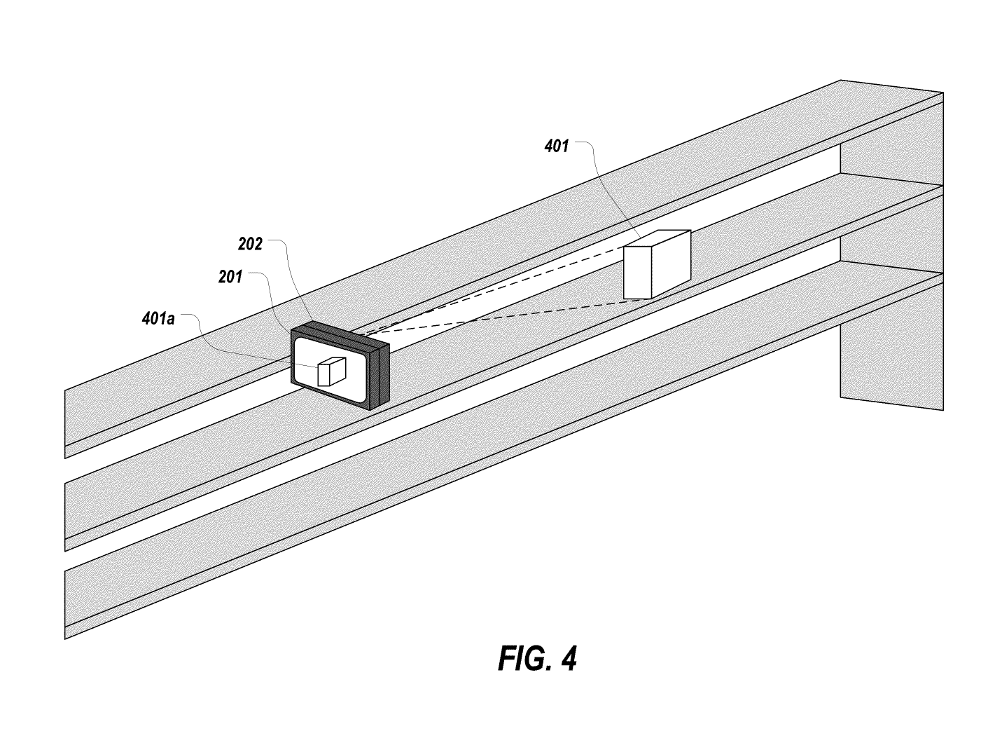

In some embodiments, when a back-to-back display set is used, one display device can be used to capture content (e.g. using camera 211) which is then provided for display on the display 210 of the other display device. This type of visual presentation can provide a sense that the display device is transparent. For example, as shown in FIG. 4, an item 401 is placed on the shelf in the line of site of camera 211 of display device 202. Camera 211 of display device 202 can capture an image or video of item 401. The captured content can be transmitted to display device 201 for display on display 210 of display device 201 (as represented by item 401a being displayed on display 210 of display device 201).

Similarly, at the same or different time, camera 211 of display device 201 can capture images or video of items on the opposite side of the display set and transmit the captured content for display on display device 202. In this way, one or both of display devices 201, 202 can function similar to a window thereby providing a view of items that are placed on the opposite side of the display device.

The sense of transparency can be enhanced by configuring the display set to recognize the eye level of a customer and modify the displayed image accordingly. The recognition of the customer's eye level can be performed continuously or periodically using one or more image recognition software modules.

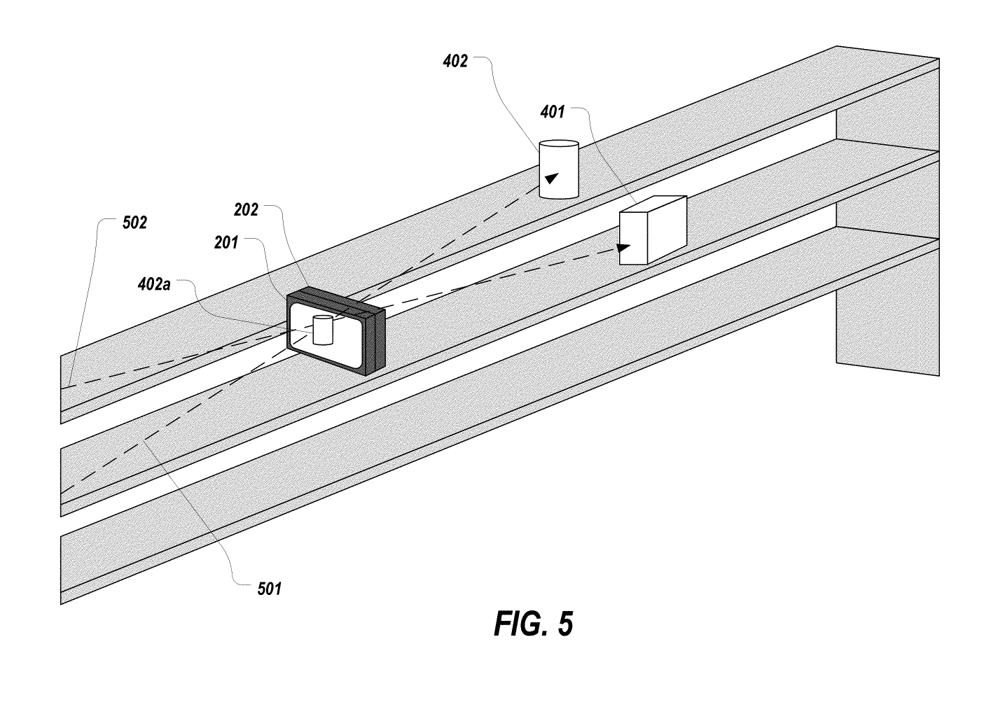

For example, FIG. 5 illustrates how the display set can detect the eye level of a customer and adjust the angle at which camera 211 captures content. Line 501 represents the eye level of a first customer as detected by display device 201 (e.g. via camera 211 of display device 201). Line 502 can represent the detected eye level of a second (taller) customer for which the display in FIG. 4 can be provided.

The display set can determine that, based on the detected eye level of the first customer, the first customer would be viewing item 402 when looking towards display device 201. Accordingly, camera 211 of display device 202 can be adjusted to capture item 402 (or alternatively, processing can be performed to crop the content being captured to include item 402).

Additionally, in some embodiments, content captured by the camera of one display device can be modified and displayed on the opposite display device. Video modifications can augment the video streams with content-sensitive layers to, for example, highlight sponsored products on the opposite side of the display device. For instance, video modification can display a product (e.g. item 401) moved from the shelf and floating in midair in the aisle. In another instance, the displayed video can be modified to show arrows pointing to a particular product (e.g. item 401) on a store shelf. In yet another instance, the displayed video can be modified to show a fictional character talking about a product on the shelf or removing the particular product from the shelf.

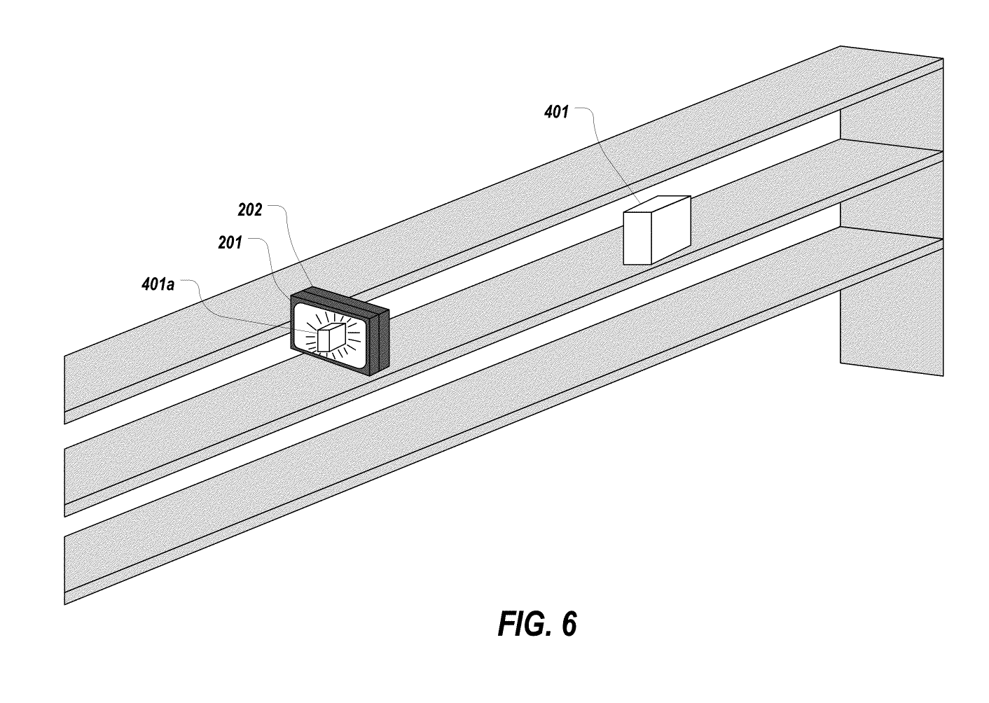

FIG. 6 illustrates an embodiment where display device 201 has augmented the content captured by camera 211 of display device 202 by causing item 401a to glow. This augmentation can be performed by logic residing on either display device or on another connected device (e.g. server 101). For example, the display device that captures the content can augment the content prior to sending the content to the other display device. Alternatively, the display device that captures the content can send the content to the other display device (or a server) where it can be augmented prior to being displayed on the other display device.

In some embodiments, the type of augmentation that is made to displayed content can be customized for a particular customer. For example, a display device can be configured to recognize the presence and identity of a customer and display customized augmentations for that customer. Customized augmentations can be effective in catching a customer's attention and influencing his or her in-aisle purchasing decisions. The dynamic and personalized nature of augmented advertising can call attention to the display devices thereby reducing the likelihood that an advertisement of an item will be overlooked.

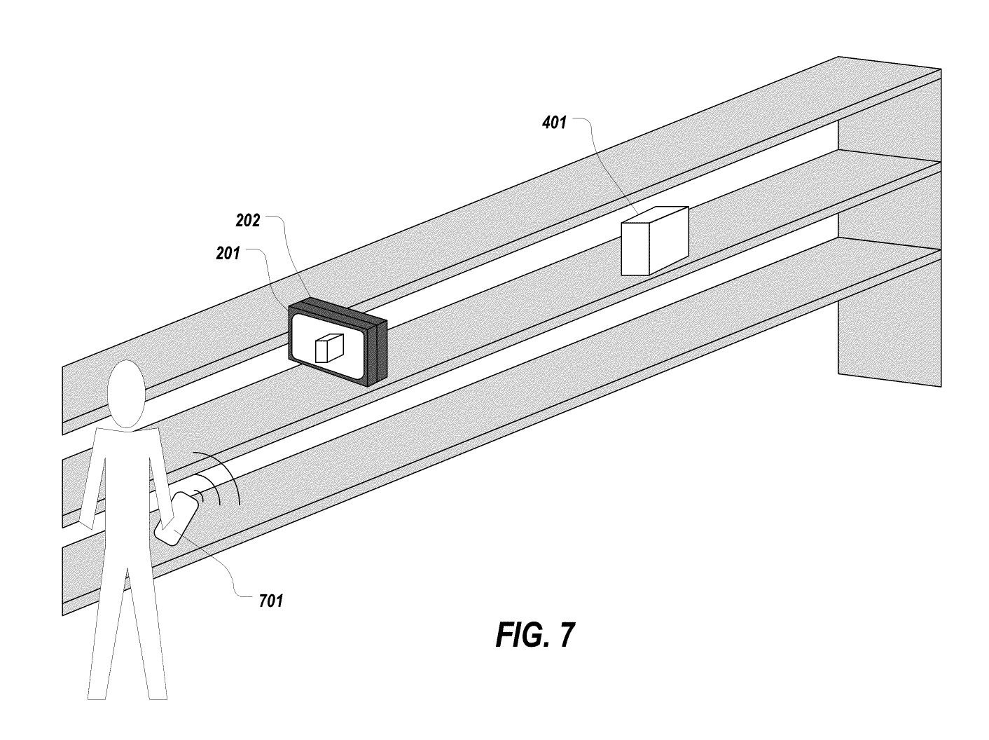

FIG. 7 illustrates an example of how a display set can identify a particular customer that is located in proximity to the display set. In this example, a customer is carrying a mobile device 701 that display device 201 (or 202) can detect once the mobile device is within some range of the display device. As shown in FIG. 7, mobile device 701 transmits a signal that can be received by display device 201. The transmitted signal can include information which identifies the customer.

This detection can occur using any known technique. For example, in some embodiments, a display device can detect wireless communication signals from device 701 as well as data contained within the signals which identify the customer. In other embodiments, a customer can carry a card (e.g. a loyalty card) that can be read by the display device (e.g. via a barcode, RFID, etc.). In such cases, the display device can read the card using one or more modules that are incorporated into the display device or otherwise connected to the display device. For example, a barcode scanner can be positioned near the end of an aisle so that the customer may scan his card upon entering the aisle.

In another example, multiple display devices can be configured to triangulate the customer's position within a retail environment using the relative signal strengths received by each display device from the customer's mobile device. In another example, the display device can receive an acoustic ID from a customer's mobile device in order to recognize the identity of the customer based on the acoustic ID of the customer's mobile device. As described above, an acoustic ID can be transmitted from the customer's mobile device via a speaker and received by the display device using a microphone. The customer's identity may also be acquired using low-frequency vibration handshaking between the customer's mobile device and the display device. In still another example, the display device can capture an image of the customer using a camera of the display device. The display device or another device or system can use one or more image recognition software modules to process the captured image and detect the identity of the customer.

Using the customer's location within the store, a system of display devices (e.g. server 101 and display devices 102, 103) can identify when the customer is in proximity to a particular display device. When a store includes multiple display devices, the system can identify which of the display devices the customer is nearest. The system can then provide a customized advertisement on the display device nearest to the customer. If a store includes multiple display devices, the customer's presence in proximity to each display device can initiate a customized advertisement. Accordingly, in some instances, as a customer walks through a store, the customer's presence can initiate a customized advertisement on each of the display devices that the customer passes.

In some embodiments, the system is configured to display a customized display at a display device when the customer is within a predetermined distance from the display device. The predetermined distance can be, for example, between about 1 foot to about 3 feet, about 3 feet to about 5 feet, about 5 feet to about 8 feet, about 8 feet to about 12 feet, about 12 feet to about 20 feet, or more than about 20 feet.

After the location and/or proximity of a customer is determined, one or more sets of display devices can coordinate to provide information to a customer as he or she travels throughout the retail environment. For instance, messages, icons, instructions, directions, or even an augmented reality avatar may travel between sequential display devices as the customer moves through the store. Although the display devices in the system may present any desired visual and/or audio content, some non-limiting examples of suitable content may include advertising information; discount and pricing information; program and preview messages; promotional campaigns; general information, such as news, traffic, and/or weather; video and/or audio streaming media; and/or near real-time footage of the customer.

Customizations can be selected based on various information known about a customer as well as on other factors. For example, server 101 can include a database that can store information about customers such as information relating to a customer's identity, a customer's loyalty card, or a customer's account. The database can be configured to store customers name, the customer's address, the customer's birthday, an image of the customer, an image unique to the customer, things that the customer likes, the customer's favorite color, the customers preferred type of music, the customer's age, the customer's gender, the customer's marital status, whether the customer has children or grandchildren, particular health problems of the customer, and other such personal information. The database can also be configured to record a purchase history that includes the products purchased by the customer and/or the date of the purchases.

In some instances, the system can analyze the customer's purchase history to identify trends in the purchase history, products frequently purchased, brands frequently purchased, the amount of money that the customer usually spends at the store over a period of time, the type of products the customer frequently purchases, and other such information. The system can additionally or alternatively analyze the customer's personal information alone or in combination with the purchase history to identify types of products that the customer may be interested in purchasing. Using this information, the system can present a customized and/or personalized advertisement to the customer.

For example, the system can identify that a customer in proximity to a display device purchases two gallons of milk each time she is in the store. The system can then display an advertisement for milk on the display device near the customer. In another example, the system can identify that a customer standing in proximity to a display device is a 50-year-old male. The system can then display an advertisement directed towards males in their 40s and 50s on the display device near the customer. In still another example, the system can identify that a customer in proximity to a display device frequently purchases high-end brand products. The system can display an advertisement of high-end products on the display device near the customer. In yet another example, the system can identify that a customer in proximity to a display device has a wife within upcoming birthday. In response to this identification, the system can advertise potential gifts, flowers, or cards to the customer. In some instances, the system can also remind the customer of his wife's upcoming birthday.

In each of these examples, the content displayed to the customer can comprise augmented content captured by one display device and displayed on another. For example, in the case that the customer's wife has an upcoming birthday, an item on the shelf that is determined to be of interest to the wife can be shown in an augmented manner as the customer walks towards a display device near the item (e.g. as shown in FIGS. 6 and 7). In other examples, the augmentation can be in the form of audio content that is added to visual content captured by the other display device. For example, the item determined to be of interest to the wife can be shown with a voice explaining the value of the item as a gift.

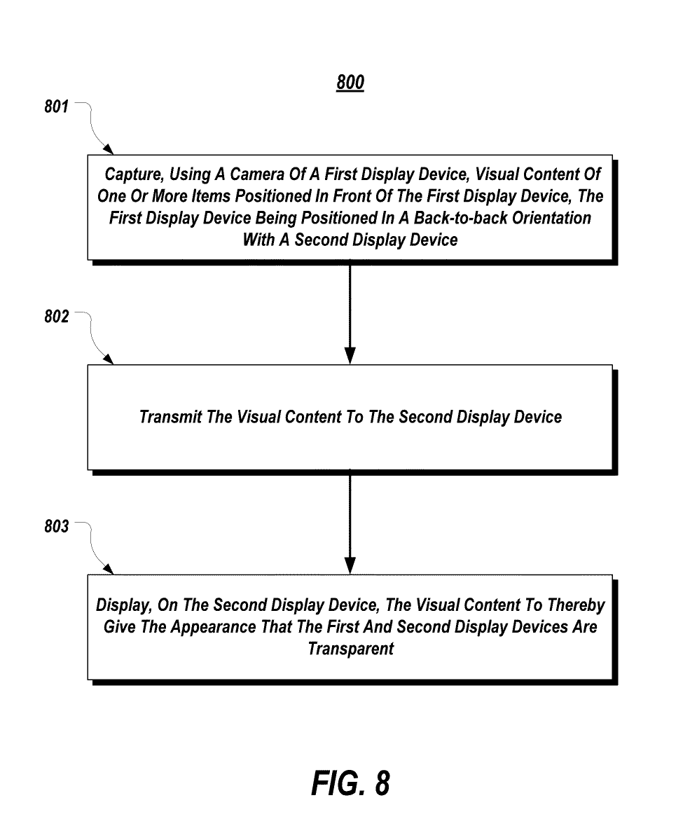

FIG. 8 illustrates a flowchart of an example method 800, performed in a system comprising two display devices in a back-to-back orientation, for capturing content with one display device and displaying the captured content on the other display device.

Method 800 includes an act 801 of capturing, using a camera of a first display device, visual content of one or more items positioned in front of the first display device, the first display device being positioned in a back-to-back orientation with a second display device. For example, display device 202 can capture visual content that includes item 401.

Method 800 includes an act 802 of transmitting the visual content to the second display device. For example, display device 202 can transmit the visual content that includes item 401 to display device 201. The visual content can be directly transferred to display device 201 or can be transferred via a server or other connected device.

Method 800 includes an act 803 of displaying, on the second display device, the visual content to thereby give the appearance that the first and second display devices are transparent. For example, display device 201 can display the visual content that includes item 401.

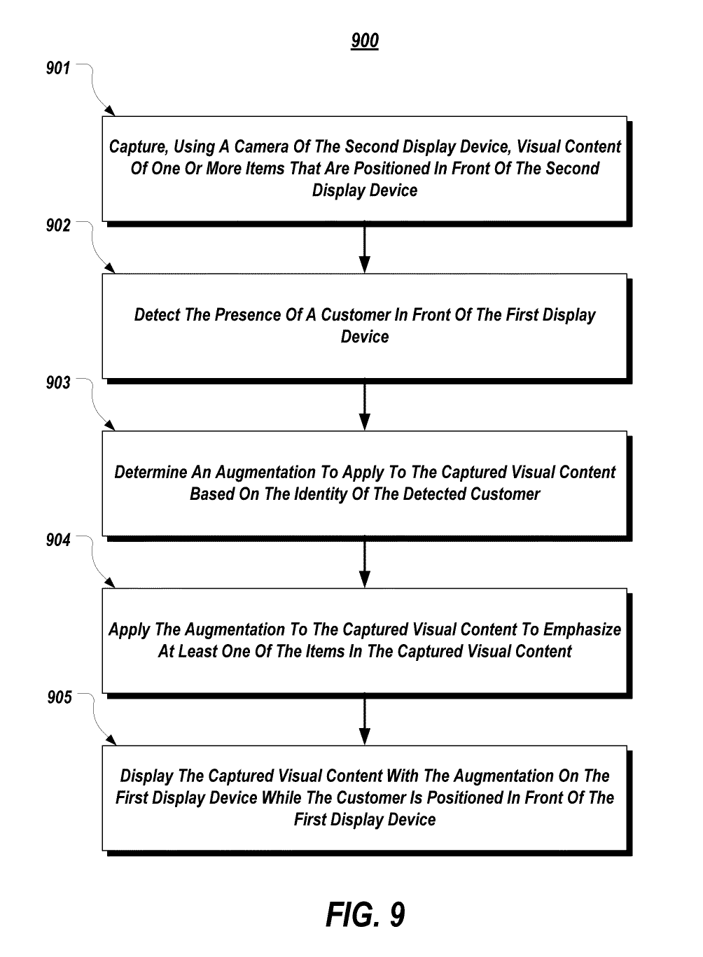

FIG. 9 illustrates a flowchart of an example method 900 for displaying a customized advertisement on a first display device by augmenting visual content captured by a second display device that is positioned in a back-to-back orientation with the first display device.

Method 900 includes an act 901 of capturing, using a camera of the second display device, visual content of one or more items that are positioned in front of the second display device. For example, display device 202 can capture visual content that includes item 401.

Method 900 includes an act 902 of detecting the presence of a customer in front of the first display device. For example, the presence of a customer in front of display device 201 can be detected by receiving information from mobile device 701 or from another item carried by the customer.

Method 900 includes an act 903 of determining an augmentation to apply to the captured visual content based on the identity of the detected customer. For example, it can be determined that the detected customer has one or more characteristics or preferences that indicate that a particular augmentation will be preferred by the customer.

Method 900 includes an act 904 of applying the augmentation to the captured visual content to emphasize at least one of the items in the captured visual content. For example, item 401 can be highlighted or otherwise emphasized in the captured visual content.

Method 900 includes an act 905 of displaying the captured visual content with the augmentation on the first display device while the customer is positioned in front of the first display device. For example, display device 201 can display the visual content with the augmentation to item 401 while the customer is positioned in front of display device 201.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed in a system comprising two display devices in a back-to-back orientation, for capturing content with one display device and displaying the captured content on the other display device, the method comprising:
capturing, using a camera of a first display device, visual content of one or more items positioned in front of the first display device, the first display device being positioned in a back-to-back orientation with a second display device;
transmitting the visual content to the second display device; and
displaying, on the second display device, the visual content to thereby give the appearance that the first and second display devices are transparent.

2. The method of claim 1, further comprising:
prior to displaying the visual content on the second display device, augmenting at least one of the one or more items captured in the visual content.

3. The method of claim 2, wherein the at least one item is augmented by the first display device prior to transmitting the visual content to the second display device.

4. The method of claim 2, wherein the at least one item is augmented by the second display device prior to displaying the visual content.

5. The method of claim 2, wherein the visual content is transmitted to a server which augments the at least one item and then transmits the augmented visual content to the second display device for display.

6. The method of claim 2, wherein augmenting the at least one item comprises highlighting the at least one item.

7. The method of claim 2, wherein augmenting the at least one item comprises repositioning the at least one item.

8. The method of claim 2, wherein augmenting the at least one item comprises adding additional content to the visual content.

9. The method of claim 8, wherein the additional content comprises visual or audio content.

10. The method of claim 2, further comprising:
identifying a customer positioned in front of the second display device;
selecting an augmentation based on the customer identity; and
wherein augmenting at least one of the one or more items captured in the visual content comprises applying the augmentation to an item that is determined to be of interest to the customer.

11. The method of claim 10, wherein the item is determined to be of interest to the customer based on a purchase history of the customer.

12. The method of claim 10, wherein the augmentation is selected based on one or more preferences identified in the customer identity.

13. The method of claim 10, wherein the augmentation is selected based on one or more characteristics of the customer identified in the customer identity.

14. The method of claim 1, wherein the first and second display devices are mounted to a shelf in a retail environment.

15. A system for displaying augmented advertisements using multiple display devices positioned in a back-to-back orientation, the system comprising:
a first display device having a front facing camera for capturing visual content of items positioned in front of the first display device; and
a second display device having a front facing camera for capturing visual content of items positioned in front of the second display device, wherein the first and second display devices are mounted in a back-to-back orientation such that the front facing cameras of each display device face in operate directions;
wherein each display device is configured to capture visual content of items positioned in front of the display device and transmit the captured visual content to the other display device for display on the other display device.

16. The system of claim 15, wherein the captured visual content is augmented prior to being displayed on the other display device.

17. The system of claim 16, wherein the captured visual content is augmented by modifying the appearance of at least one item in the captured visual content.

18. The system of claim 16, wherein the captured visual content is augmented by adding visual or audio content to the captured visual content.

19. The system of claim 16, wherein the captured visual content is augmented based on an identity of a customer detected within a specified proximity of the other display device.

20. A method for displaying a customized advertisement on a first display device by augmenting visual content captured by a second display device that is positioned in a back-to-back orientation with the first display device, the method comprising:
capturing, using a camera of the second display device, visual content of one or more items that are positioned in front of the second display device;
detecting the presence of a customer in front of the first display device;
determining an augmentation to apply to the captured visual content based on the identity of the detected customer;
applying the augmentation to the captured visual content to emphasize at least one of the items in the captured visual content; and
displaying the captured visual content with the augmentation on the first display device while the customer is positioned in front of the first display device.
